(19) United States
(12) Patent Application Publication
(10) Pub. No.: US 2008/0034928 A1
(43) Pub. Date: Feb. 14, 2008

(54) Tool member having indicator device

(76) Inventor: Shaw Shyan Sheu, Taichung Hsien (TW)

Correspondence Address: CHARLES E. BAXLEY, ESQ., 90 JOHN STREET, THIRD FLOOR, NEW YORK, NY, 10038, US

(21) Appl. No.: 11/472,679

(22) Filed: Jun. 21, 2006

(51) Int. Cl. B25B 23/16; B25G 1/00

(52) U.S. Cl. 81/177.1; 81/436

(57) ABSTRACT

A tool member includes an indicator device applied onto the tool member for indicating a type or model or standard or size or dimension of the tool member. The tool member may include a neck portion having the indicator device applied on the outer portion, and arranged for allowing the indicator device to be clearly seen by the users, such that the users may easily and quickly find and select or fetch the tool member having the required type and/or the required size or dimension, without rummaging the tool boxes.

### BACKGROUND OF THE INVENTION

1. Field of the Invention

The present invention relates to a tool member, and more particularly to a tool member including an indicator device having a high-visibility color different from that of the tool member, and offered as an increased visual aid to verify the type or the model or the standard of the tool member and to allow the required type or model or standard of the tool member to be easily and quickly selected by the users.

2. Description of the Prior Art

Typical tool members, such as sockets, tool extensions, tool bits or screw driver bits, comprise various kinds of types or models or standards, such as PHILLIPS heads, flat or rectangular heads, star-drive heads, or the like, and may comprise different sizes or dimensions. In addition, the screw driver bits may be mixed together and disposed within a tool box or the like.

When the users are required to select one of the tool members or tool bits or screw driver bits, they may have to rummage the tool box in order to find and to select the required tool members or tool bits or screw driver bits of the required types or models or standards or sizes or dimensions. The typical tool members have no suitable indicator device for allowing the tool member to be easily obtained or fetched, when required.

The present utility model has arisen to mitigate and/or obviate the afore-described disadvantages of the conventional tool members.

### SUMMARY OF THE INVENTION

The primary objective of the present invention is to provide an indicator device including a high-visibility color different from that of the tool member, and offered as an increased visual aid to verify the type or the model or the standard of the tool member and to allow the required type or model or standard of the tool member to be easily and quickly selected by the users.

In accordance with one aspect of the invention, there is provided a tool member including an indicator device applied onto the tool body, for indicating a type or model or standard or size or dimension of the tool member.

The tool member may include a neck portion having the indicator device applied thereon, and arranged for allowing the indicator device to be clearly seen by the users, such that the users may easily and quickly find and select or fetch the tool member having the required type and/or the required size or dimension, without rummaging the tool boxes.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a tool member in accordance with the present invention;

FIG. 2 is another perspective view of the tool member;

FIGS. 3, 4 is a perspective view similar to FIG. 2, illustrating the other arrangements of the tool member;

FIG. 5 is a partial exploded view illustrating the operation of the tool member; and

FIG. 6 is a perspective view illustrating the other application of the tool member.

### DETAILED DESCRIPTION OF THE PREFERRED EMBODIMENT

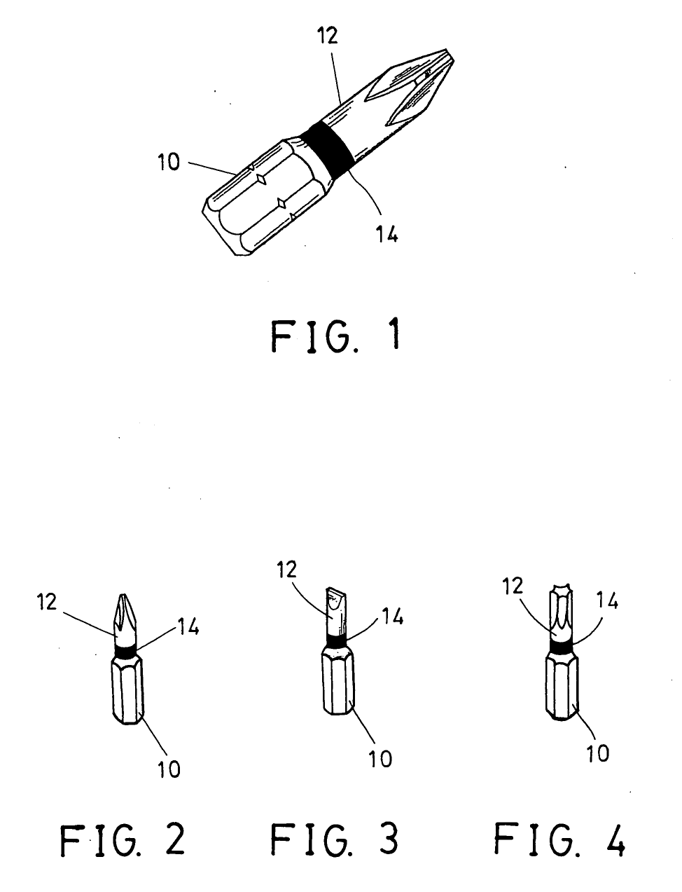

Referring to the drawings, and initially to FIGS. 1 and 2, a tool member 10 in accordance with the present invention may be selected from various kinds of tool members 10, such as sockets, tool extensions, tool bits or screw driver bits, etc., and are normally made of metal materials, and comprise a single color formed thereon, and comprise various kinds of types or models or standards or sizes or dimensions, or the like.

For example, the typical screw driver bits 10 may comprise various kinds of types or models or standards, such as PHILLIPS heads (FIGS. 1-2 and 5-6), flat or rectangular heads (FIG. 3), star-drive heads (FIG. 4), or the like, and may further comprise different sizes or dimensions. The tool member 10 further includes a narrowed neck portion 12 formed or provided thereon.

In addition, the tool member 10 includes a tool body 10 having an indicator device 14, such as a ring-shaped layer 14 applied onto or around the neck portion 12 thereof, and having a high-visibility color different from that of the tool member 10, and offered as an increased visual aid to verify the type or the model or the standard or the size or the dimension of the tool member 10, for allowing the required type of the tool member 10 having the required size or dimension to be easily and quickly found and selected or fetched.

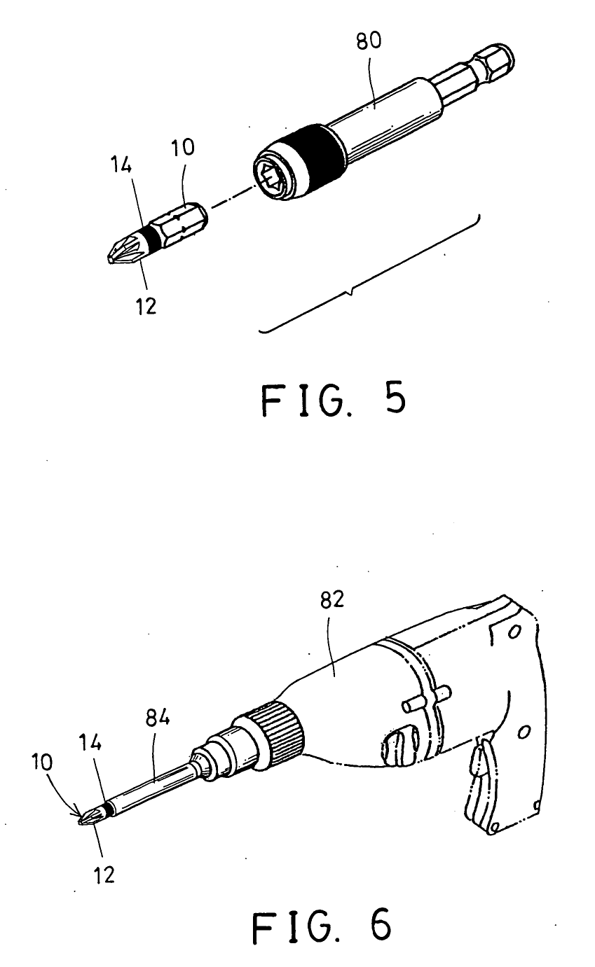

In operation, as shown in FIGS. 5 and 6, when the tool member 10 is attached to the other tool devices, such as tool extensions 80 (FIG. 5), or tool shanks 84 of power driving tools 82 (FIG. 6), etc., the neck portion 12 and the indicator device 14 of the tool member 10 may be exposed or extended out of the tool devices 80, 82, 84, and may be clearly seen by the users, such that the users may easily and quickly find and select or fetch the tool member 10 having the required type and/or the required size or dimension, without rummaging the tool boxes.

Accordingly, the tool member in accordance with the present invention includes a high-visibility color different from that of the tool member, and offered as an increased visual aid to verify the type or the model or the standard of the tool member and to allow the required type or model or standard of the tool member to be easily and quickly selected by the users.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A tool member comprising:
a tool body, and
an indicator device applied onto said tool body for indicating a type of said tool member.

2. The tool member as claimed in claim 1, wherein said tool body includes a neck portion having said indicator device applied thereon.
